(19) United States
(12) Patent Application Publication
(10) Pub. No.: US 2014/0351408 A1
(43) Pub. Date: Nov. 27, 2014

(54) UTILIZING AUGMENTED REALITY FOR LOCATING COMPUTER HARDWARE ASSOCIATED TO A REPORTED INCIDENT

(71) Applicant: INTERNATIONAL BUSINESS MACHINES CORPORATION, Armonk, NY (US)

(72) Inventors: Eric M. Anderson, Friendswood, TX (US); Robert A. Davis, Atlanta, GA (US); Christopher J. Dawson, Arlington, VA (US); Salvatore T. Lococo, Rhinebeck, NY (US)

(73) Assignee: INTERNATIONAL BUSINESS MACHINES CORPORATION, Armonk, NY (US)

(21) Appl. No.: 13/898,551

(22) Filed: May 21, 2013

(51) Int. Cl. H04L 12/26

(52) U.S. Cl. CPC H04L 43/0823
USPC 709/224

(57) ABSTRACT

Program code on a client computer receives an image of computer hardware and a unique identifier of the computer hardware. The program code generates a request that includes the unique identifier, a location of a client computer, and profile information of an end-user logged into the client computer. The program code sends the request to a server computer, and forwards a version of the request to an incident management system that in response to receiving the request extracts information associated to the computer hardware. The program code receives the information extracted, and forwards the information to the client computer. The program code overlays at least some of the information forwarded, onto the image of the computer hardware. The program code generates a map that displays on the screen of the client computer the image of the computer hardware overlaid with at least some of the information forwarded.

### BACKGROUND

1. Field of the Invention

The present invention relates generally to augmented reality, and more particularly to a data center augmented reality program for locating computer hardware associated to a reported incident.

2. Description of the Related Art

Data centers are widely used by large organizations to house computer systems that include server computers and computer network equipment through which a large amount of data can be processed, transferred, stored and used by the organizations to manage daily internal business operations and also to provide services to customers. It is common for the server computers and computer network equipment to experience failures (e.g., computer hardware or computer software issues) at some point in time during their useful life, which can lead to lost revenue and decreased customer satisfaction. Therefore, to ensure the internal business operations run seamlessly with minimized interruptions and to ensure the services provided to customers are reliable, then the server computers and computer network equipment must be well maintained.

When an interruption in the services provided by a data center occurs it is known for a customer to call into a technician (e.g., a support technical specialist) for the data center to report the interruption. The technician can try to troubleshoot the root cause of the interruption and restore the service for the customer. Specifically, if the root cause is associated to a computer or network equipment within a data center at which the technician does not have physical access to, then the technician may try to troubleshoot the root cause and restore the service remotely. However, the technician may not be able to troubleshoot the root cause and/or restore the service remotely, because physical access to the computers and equipment may be needed in order to restore the service. Therefore, another technician who can physically access the computers and network equipment within the data center must be located.

It is known to for a technician who is unable to restore the service remotely to open a trouble ticket (i.e., incident), so that another technician who can physically access the computers and network equipment within the data center can restore the service. However, time may be wasted in readily locating another technician who can physically access the computers and network equipment associated to an interruption of the service that is provided by the data center. Moreover, even when a technician is located and can physically access the computers and network equipment within the data center, time can be further wasted by the technician in trying to determine which one of the computers or components of the network equipment within the data center is actually associated to a reported interruption in the service. In addition, it is known for the technician to utilize existing data center management computer software to monitor and identify computer and network equipment within the data center that may be causing an interruption in the service, but the data center management software may not be readily available to the technician.

### SUMMARY

Aspects of an embodiment of the present invention disclose a method, computer system, and program product for locating computer hardware associated to a reported incident using virtual augmentation. One or more computers receive an image of computer hardware and a unique identifier of the computer hardware that is in the image. At least one of the one or more computers generates a request that includes the unique identifier, a location of a client computer, and profile information of an end-user logged into the client computer. At least one of the one or more computers sends the request to a server computer. At least one of the one or more computers forwards a version of the request to an incident management system that in response to receiving the request extracts information, from one or more databases, associated to the computer hardware that has the unique identifier. At least one of the one or more computers receives the information that is extracted by the incident management system. At least one of the one or more computers forwards the information that is extracted by the incident management system to the client computer. At least one of the one or more computers overlays at least some of the information that is forwarded, onto the image of the computer hardware for display on a screen of the client computer. At least one of the one or more computers generates a map that displays on the screen of the client computer the image of the computer hardware overlaid with at least some of the information that is forwarded.

### BRIEF DESCRIPTION OF THE SEVERAL VIEWS OF THE DRAWINGS

The subject matter which is regarded as an embodiment of the present invention is particularly pointed out and distinctly claimed in the claims at the conclusion of the specification. One manner in which recited features of an embodiment of the present invention can be understood is by reference to the following detailed description of embodiments, taken in conjunction with the accompanying drawings in which:

FIG. 1 is a block diagram of a distributed computer system, including a client computer having augmented reality client software and a server computer having augmented reality server software, wherein the augmented reality client software and the augmented reality server software are program code that allows an end-user via the client computer to receive a configuration item associated to a reported incident and readily display on a screen of the client computer a location of computer hardware to which the configuration item is assigned according to an embodiment of the present invention.

FIGS. 2A and 2B are flowcharts illustrating operations of the program code according to an embodiment of the present invention.

FIG. 3 is a block diagram depicting internal and external components of the client computers and the server computers of FIG. 1 according to an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like, conventional procedural programming languages such as the “C” programming language, a hardware description language such as VERILOG, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Exemplary embodiments now will be described more fully herein with reference to the accompanying drawings. This disclosure may, however, be embodied in many different forms and should not be construed as limited to the exemplary embodiments set forth herein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

Embodiments of the present invention provide a data center augmented reality program for locating computer hardware associated to a reported incident.

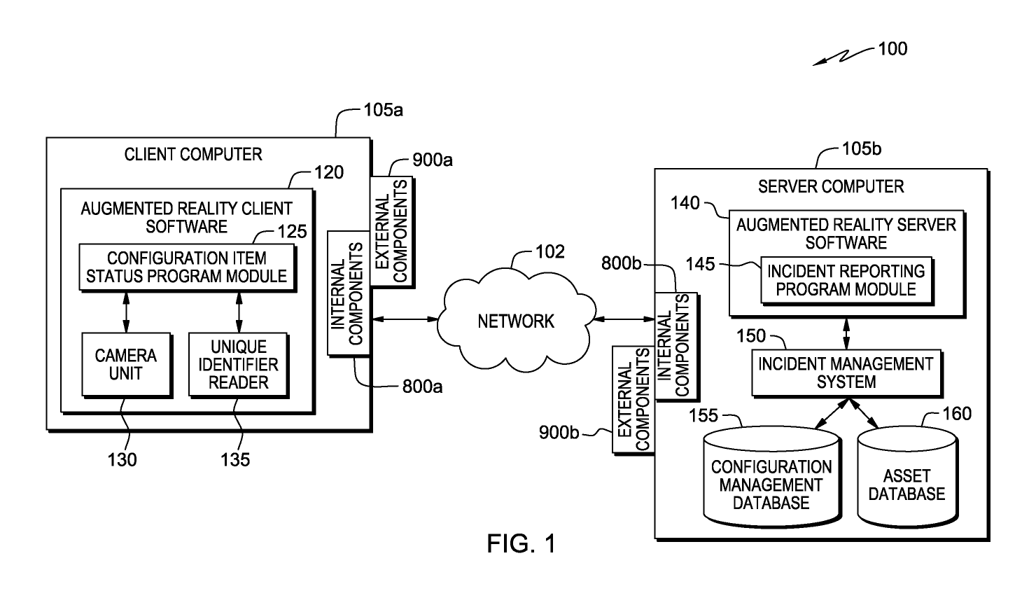

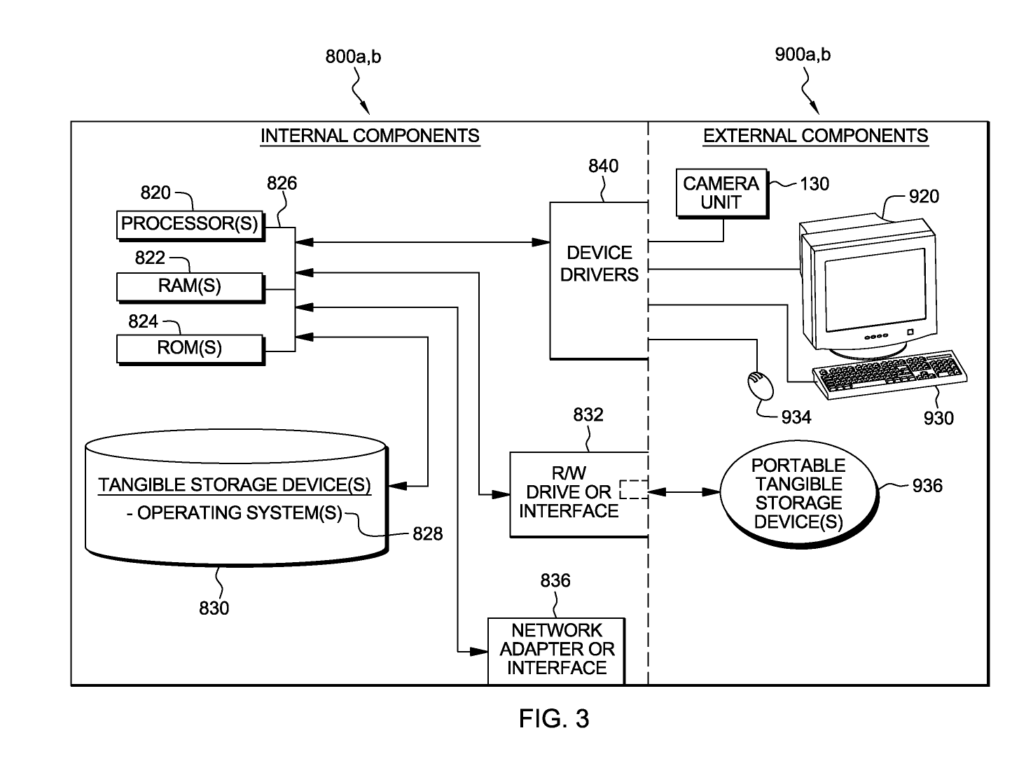

FIG. 1 illustrates computer system 100 that includes client computers 105a, network 102, and server computer 105b. Client computer 105a and server computer 105b can interact and exchange data (i.e., communicate) with each other via network 102. Client computer 105a and server computer 105b each include respective internal components 800a and 800b, and respective external components 900a and 900b, as described below in more detail with respect to FIG. 3. Client computer 105a is installed with augmented reality client software 120 having configuration item status program module 125. Moreover, client computer 105a includes camera unit 130 and unique identifier reader 135. Unique identifier reader 135 can be a two-dimensional barcode reader (e.g., quick response code scanner) and/or a radio-frequency identification (RFID) reader. Server computer 105b is installed with augmented reality server software 140 having incident reporting program module 145. In addition, server computer 105b further includes incident management system 150, configuration management database 155, and asset database 160.

Augmented reality client software 120 allows an end-user (e.g., a computer technician) of client computer 105a to capture, via camera unit 130, an image of computer hardware and send a request to server computer 105b in order to retrieve status of a configuration item (i.e., computer software component and/or computer hardware component) assigned to (i.e., installed on) the computer hardware. Specifically, configuration item status program module 125, of augmented reality client software 120, can send a request to augmented reality server software 140 in order to retrieve the status of one or more configuration items assigned to the computer hardware captured in the image. The request can be triggered manually by the end-user of client computer 105a, or augmented reality client software 120 can be configured to send the request based on a schedule (e.g., an hourly or a daily basis) to augmented reality server software 140. In the disclosed embodiment, the request includes the location of client computer 105a, profile information (e.g., unique identifier and configurable display preferences for overlaying information onto the image) of the end-user logged into client computer 105a, and a unique identifier (unique ID) (e.g., a unique ID associated to a RFID tag attached to the computer hardware in the image) that is assigned to the computer hardware in the image. The unique ID assigned to the computer hardware captured in the image can be retrieved by unique identifier reader 135 if client computer 105a is within range for unique identifier reader 135 to detect and read the unique ID. Subsequent to reading the unique ID, unique identifier reader 135 sends the unique ID to augmented reality client software 120 for configuration item status program module 125 to include in the request, as mentioned above, that is sent to augmented reality server software 140.

Furthermore, to retrieve the status of configuration items assigned to the computer hardware captured in the image, incident reporting program module 145 of augmented reality server software 140 can forward the request received to incident management system 150. Incident management system 150 manages incidents (e.g., incident tickets) that are reported about any computer hardware (e.g., incidents that are reported about a configuration item assigned to computer hardware) having a record within asset database 160. Thus, asset database 160 stores records of computer hardware, wherein the records include physical information about the computer hardware such as location, rack number, and any other physical information that can be used to identify, in three dimensions, where the computer hardware is located. In particular, incident management system 150 can utilize the unique ID that is within the request received to query configuration management database 155 for information that includes the status parameter value for each of the configuration items that are assigned to the computer hardware having the unique ID, and that are associated to an incident that is reported and being managed by incident management system 150. For example, each of the configuration items assigned to the computer hardware having the unique ID can have a status parameter value that indicates whether the configuration item is functioning properly or is not functioning properly.

In particular, each of the configuration items that are assigned to the computer hardware having the unique ID are each defined as a record, within configuration management database 155, having fields for storing information, wherein one of the fields contains the address to a separate record, within asset database 160, of the computer hardware having the unique ID. The record of the computer hardware having the unique ID can have one or more fields one of which is a status parameter value that indicates whether the computer hardware having the unique ID is functioning properly or is not functioning properly.

Thus, in the disclosed embodiment, configuration management database 155 stores records having information about each of the configuration items assigned to the computer hardware, wherein the information can include the following: a status parameter value for each of the configuration items, a reported incident associated to the configuration items, address to record of computer hardware to which the configuration items are assigned, and connection information (e.g., uniform resource locators) for an asset management system that can be utilized to determine a physical location of each asset that the configuration items represent. In addition to storing records having the physical information about the computer hardware, as mentioned above, asset database 160 also stores records having information about the computer hardware that can include the following: the status parameter value for the computer hardware, coordinates (e.g., x, y, and z coordinates) defining a physical location of the computer hardware, and other asset information about the computer hardware such as financial or lease information. Accordingly, based on the request that is forwarded incident management system 150 can utilize the unique ID within the request to extract the information stored in asset database 160 and associated to the computer hardware having the unique ID, and also to extract the information stored in configuration management database 155 and associated to the configuration items assigned to the computer hardware having the unique ID.

Furthermore, incident management system 150 can send information that is extracted to incident reporting program module 145, and incident reporting program module 145 can forward the information that is extracted to augmented reality client software 120, and even utilize the information that is extracted to generate an electronic report that indicates the status about the computer hardware having the unique ID, and about each of the configuration items assigned to the computer hardware having the unique ID. Augmented reality client software 120 can overlay the information forwarded from incident reporting program module 145 onto the image of the computer hardware having the unique ID that is captured via camera unit 130 of client computer 105a. As a result, the end-user of client computer 105a can view information about the computer hardware within the image captured via camera unit 130 as well as view information about configuration items assigned to the computer hardware, which can allow the end-user to readily locate computer hardware and configuration items associated to reported incidents. Moreover, augmented reality client software 120 can utilize the coordinates within the information forwarded from incident reporting program module 145 to generate a map that displays on a screen of client computer 105a an image of the computer hardware having the unique ID. In particular, the image of the computer hardware having the unique ID is displayed on the map at a specific location defined by the coordinates within the information forwarded from incident reporting program module 145. Furthermore, augmented reality client software 120 can be configured by the end-user to select which of the information forward to overlay onto the image of the computer hardware having the unique ID that is displayed on the map.

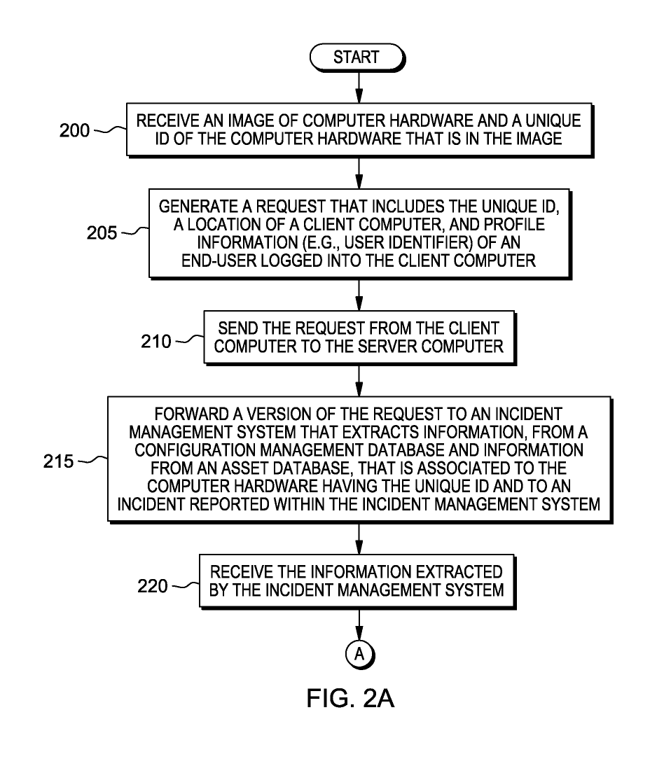

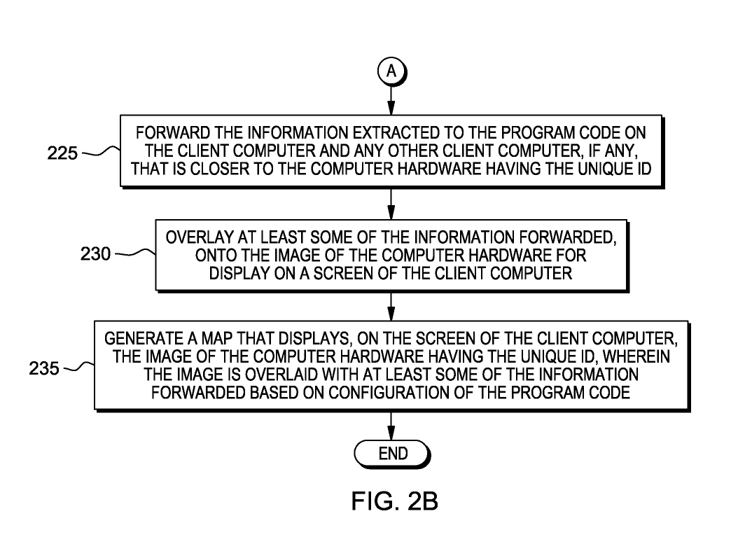

FIGS. 2A-2B are flowcharts illustrating the steps of the program code, augmented reality client software 120 and augmented reality server software 140, for locating computer hardware associated to a reported incident (e.g., an incident ticket). In the disclosed embodiment, the program code receives an image of computer hardware and a unique ID of the computer hardware that is in the image (block 200). The image of the computer hardware can be captured via camera unit 130 and sent to the program code, and the unique ID can be read via unique identifier reader 135 and sent along with the image to the program code. Next, in response to receiving the unique ID of the computer hardware, the program code generates a request that includes the unique ID, a location of client computer 105a, and profile information (e.g., unique identifier and configurable display preferences for overlaying information onto the image) of an end-user logged into client computer 105a (block 205). The request generated is utilized by the program code to retrieve information about each reported incident that is associated to the computer hardware having the unique ID. In the disclosed, embodiment, the program code receives only one unique ID to include in the request generated, but in other embodiments the program code can receive more than one unique ID to include in the request generated.

Subsequent to generating the request, the program code on client computer 105a sends the request from client computer 105a to server computer 105b (block 210). Next, the program code on server computer 105b forwards a version of the request to incident management system 150 that extracts information, from configuration management database 155 and information from asset database 160, that is associated to the computer hardware having the unique ID and to an incident reported within incident management system 150 (block 215). Specifically, incident management system 150 can utilize the unique ID that is within the request received to generate a query that extracts, from configuration management database 155, information within records of each the configuration items that are assigned to the computer hardware having the unique ID and are associated to an incident that is reported within incident management system 150. In addition, incident management system 150 can utilize the unique ID that is within the request received and/or utilize an address within records of the configuration items assigned to the computer hardware having the unique ID in order to generate a query that extracts from asset database 160 information within the record of the computer hardware having the unique ID, wherein the information can include the following: physical information of the computer hardware having the unique ID, serial number of the computer hardware having the unique ID, status of the computer hardware having the unique ID, a reported incident associated to the computer hardware having the unique ID, qualified computer technicians who can resolve incidents reported about the computer hardware having the unique ID, addresses to records of the configuration items assigned to the computer hardware having the unique ID, a uniform resource locator (URL) for access to instructions about how to resolve an incident reported about the computer hardware having the unique ID, coordinates (e.g., x, y, and z coordinates) defining a physical location of the computer hardware having the unique ID.

Subsequently, the program code on server computer 105b receives the information extracted by incident management system 150 (block 220), and forwards the information extracted to the program code on client computer 105a and any other client computer 105a, if any, that is closer to the computer hardware having the unique ID (block 225). Specifically, the program code on server computer 105b can determine the closest computer having augmented related client software 120 by comparing the coordinates (e.g., x, y, and z coordinates), within the information extracted, defining a physical location of the computer hardware having the unique ID to the location of client computer 105a and to any other computer, connected to network 102 within computer system 100, having augmented reality client software 120. Next, the program code on client computer 105a overlays at least some of the information forwarded, onto the image of the computer hardware for display on a screen of client computer 105a (block 230). Thus, the program code on client computer 105a and/or server computer 105b can be configured to selectively define how much of the information extracted to overlay onto the image of the computer hardware for display on the screen of client computer 105a.

For example, a system programmer/administrator, based on the profile information in the request generated by the program code on client computer 105a, can configure the program code on server computer 105b to define how much of the information extracted to forward to the program code on client computer 105a and overlay onto the image of the computer hardware. In addition, the end-user can also configure the program code (e.g., configure display preferences within their profile information) on client computer 105a to further define how much of the information forwarded by the program code on server computer 105 to overlay onto the image of the computer hardware. Accordingly, as an example the system programmer/administrator may configure the program code on server computer 105b to forward to the program code on client computer 105a only the serial number and the status of the computer hardware to overlay onto the image of the computer hardware, for display on the screen of client computer 105a. However, in the above example the end-user of client computer 105a may configure the program code on client computer 105a to overlay onto the image of the computer hardware only the status of the computer hardware, for display on the screen of client computer 105a. Thus, in the above example, even though both the serial number and the status of the computer hardware are forwarded to client computer 105a the end-user may further limit how much of the information forwarded to overlay onto the image of the computer hardware.

Subsequently, the program code on client computer 105a generates a map that displays, on the screen of client computer 105a, the image of the computer hardware having the unique ID, wherein the image is overlaid with at least some of the information forwarded based on configuration of the program code, as described above (block 235). Specifically, the program code on client computer 105 can utilize the image of the computer hardware and the coordinates (e.g., x, y, and z coordinates) defining a physical location of the computer hardware having the unique ID, in order to generate the map. The map generated can assist the end-user of client computer 105a with locating the computer hardware having the unique ID. Subsequent to generating the map the program code ends.

FIG. 3 is a block diagram depicting a set of internal components 800a and 800b and a set of external components 900a and 900b that correspond to respective client computer 105a and server computer 105b. Internal components 800a and 800b each include one or more processors 820, one or more computer readable RAMs 822 and one or more computer readable ROMs 824 on one or more buses 826, and one or more operating systems 828 and one or more computer readable tangible storage devices 830. The one or more operating systems 828 and augmented reality client software 120 on client computer 105a; and augmented reality server software 140 on server computer 105b are stored on one or more of the respective computer readable tangible storage devices 830 for execution by one or more of the respective processors 820 via one or more of the respective RAMs 822 (which typically include cache memory). In the embodiment illustrated in FIG. 3, each of the computer readable tangible storage devices 830 is a magnetic disk storage device of an internal hard drive. Alternatively, each of the computer readable tangible storage devices 830 is a semiconductor storage device such as ROM 824, EPROM, flash memory or any other computer readable tangible storage device that can store a computer program and digital information.

Each set of internal components 800a and 800b includes a R/W drive or interface 832 to read from and write to one or more portable computer readable tangible storage devices 936 such as CD-ROM, DVD, memory stick, magnetic tape, magnetic disk, optical disk or semiconductor storage device. Augmented reality client software 120 on client computer 105a; and augmented reality server software 140 on server computer 105b can be stored on one or more of the respective portable computer readable tangible storage devices 936, read via the respective R/W drive or interface 832 and loaded into the respective hard drive or computer readable tangible storage device 830.

Furthermore, each set of internal components 800a and 800b also includes a network adapter or interface 836 such as TCP/IP adapter card, wireless wi-fi interface card, or 3G or 4G wireless interface card or other wired or wireless communication link. Augmented reality client software 120 on client computer 105a; and augmented reality server software 140 on server computer 105b can be downloaded to respective computers 105a and 105b from an external computer or external storage device via a network (for example, the Internet, a LAN, or a WAN) and respective network adapters or interfaces 836. From the network adapter or interface 836, augmented reality client software 120 on client computer 105a; and augmented reality server software 140 on server computer 105b are loaded into at least one respective hard drive or computer readable tangible storage device 830. The network may comprise copper wires, optical fibers, wireless transmission, routers, firewalls, switches, gateway computers and/or servers.

Each set of external components 900a and 900b can include a camera unit 130, a computer display monitor 920, a keyboard 930, and a computer mouse 934. External components 900a and 900b can also include touch screens, virtual keyboards, touch pads, pointing devices, and other human interface devices. Each set of internal components 800a and 800b also includes device drivers 840 to interface to computer display monitor 920, keyboard 930 and computer mouse 934. The device drivers 840, R/W drive or interface 832 and network adapter or interface 836 comprise hardware and software in which the software is stored in computer readable tangible storage device 830 and/or ROM 824.

It should be appreciated that FIG. 3 provides only an illustration of one implementation and does not imply any limitations with regard to the environments in which different embodiments may be implemented. A variety of modifications to the depicted environments may be implemented. Moreover, a variety of modifications to the depicted environments may be made based on design and implementation requirements.

In accordance with the foregoing, a method, a computer system, and a computer program product have been disclosed for locating computer hardware associated to a reported incident. However, numerous modifications substitutions can be made without deviating from the scope of an embodiment of the invention. Therefore, one or more embodiments of the invention have been disclosed by way of example and not limitation.

What is claimed is:

1. A method for locating computer hardware associated to a reported incident comprising:
receiving an image of computer hardware and a unique identifier of the computer hardware that is in the image;
generating a request that includes the unique identifier, a location of a client computer, and profile information of an end-user logged into the client computer;
sending the request to a server computer;
forwarding a version of the request to an incident management system that in response to receiving the request, extracts information, from one or more databases, associated to the computer hardware that has the unique identifier;
receiving the information that is extracted by the incident management system;
forwarding the information that is extracted by the incident management system to the client computer;
overlaying at least some of the information that is forwarded, onto the image of the computer hardware for display on a screen of the client computer; and
generating a map that displays on the screen of the client computer the image of the computer hardware overlaid with at least some of the information that is forwarded.

2. The method of claim 1, wherein the unique identifier of the computer hardware is associated to a RFID tag attached to the computer hardware that is in the image.

3. The method of claim 1, wherein the profile information comprises a unique identifier of an end-user logged into the client computer, and configurable display preferences to determine how much of the information that is forwarded to overlay onto the image.

4. The method of claim 1, wherein the information that is forwarded comprises status of the computer hardware that is in the image, a reported incident associated to the computer hardware that is in the image, qualified computer technicians who can resolve the reported incident associated to the computer hardware that is in the image, addresses to records of computer software components and computer hardware components assigned to the computer hardware that is in the image, a uniform resource locator for access to instructions about how to resolve the reported incident associated to the computer hardware that is in the image, coordinates defining a physical location of the computer hardware that is in the image.

5. The method of claim 1, wherein the step of generating the map comprises utilizing the image of the computer hardware and coordinates, which are within the information that is forwarded, defining a physical location of the computer hardware that is in the image.

6. A computer program product for locating computer hardware associated to a reported incident comprising:
a computer readable storage medium and program instructions stored on the computer readable storage medium, the program instructions comprising:
program instructions to receive an image of computer hardware and a unique identifier of the computer hardware that is in the image;
program instructions to generate a request that includes the unique identifier, a location of a client computer, and profile information of an end-user logged into the client computer;
program instructions to send the request to a server computer;
program instructions to forward a version of the request to an incident management system that in response to receiving the request, extracts information, from one or more databases, associated to the computer hardware that has the unique identifier;
program instructions to receive the information that is extracted by the incident management system;
program instructions to forward the information that is extracted by the incident management system to the client computer;
program instructions to overlay at least some of the information that is forwarded, onto the image of the computer hardware for display on a screen of the client computer; and
program instructions to generate a map that displays on the screen of the client computer the image of the computer hardware overlaid with at least some of the information that is forwarded.

7. The computer program product of claim 6, wherein the unique identifier of the computer hardware is associated to a RFID tag attached to the computer hardware that is in the image.

8. The computer program product of claim 6, wherein the profile information comprises a unique identifier of an end-user logged into the client computer, and configurable display preferences to determine how much of the information that is forwarded to overlay onto the image.

9. The computer program product of claim 6, wherein the information that is forwarded comprises status of the computer hardware that is in the image, a reported incident associated to the computer hardware that is in the image, qualified computer technicians who can resolve the reported incident associated to the computer hardware that is in the image, addresses to records of computer software components and computer hardware components assigned to the computer hardware that is in the image, a uniform resource locator for access to instructions about how to resolve the reported incident associated to the computer hardware that is in the image, coordinates defining a physical location of the computer hardware that is in the image.

10. The computer program product of claim 6, wherein the step of generating the map comprises utilizing the image of the computer hardware and coordinates, which are within the information that is forwarded, defining a physical location of the computer hardware that is in the image.

11. A computer system for locating computer hardware associated to a reported incident comprising:
a computer readable storage medium and program instructions stored on the computer readable storage medium, the program instructions comprising:
program instructions to receive an image of computer hardware and a unique identifier of the computer hardware that is in the image;
program instructions to generate a request that includes the unique identifier, a location of a client computer, and profile information of an end-user logged into the client computer;
program instructions to send the request to a server computer;
program instructions to forward a version of the request to an incident management system that in response to receiving the request, extracts information, from one or more databases, associated to the computer hardware that has the unique identifier;
program instructions to receive the information that is extracted by the incident management system;
program instructions to forward the information that is extracted by the incident management system to the client computer;
program instructions to overlay at least some of the information that is forwarded, onto the image of the computer hardware for display on a screen of the client computer; and
program instructions to generate a map that displays on the screen of the client computer the image of the computer hardware overlaid with at least some of the information that is forwarded.

12. The computer system of claim 11, wherein the unique identifier of the computer hardware is associated to a RFID tag attached to the computer hardware that is in the image.

13. The computer system of claim 11, wherein the profile information comprises a unique identifier of an end-user logged into the client computer, and configurable display preferences to determine how much of the information that is forwarded to overlay onto the image.

14. The computer system of claim 11, wherein the information that is forwarded comprises status of the computer hardware that is in the image, a reported incident associated to the computer hardware that is in the image, qualified computer technicians who can resolve the reported incident associated to the computer hardware that is in the image, addresses to records of computer software components and computer hardware components assigned to the computer hardware that is in the image, a uniform resource locator for access to instructions about how to resolve the reported incident associated to the computer hardware that is in the image, coordinates defining a physical location of the computer hardware that is in the image.

15. The computer system of claim 11, wherein the step of generating the map comprises utilizing the image of the computer hardware and coordinates, which are within the information that is forwarded, defining a physical location of the computer hardware that is in the image.
